(19) United States
(12) Patent Application Publication
(10) Pub. No.: US 2007/0133978 A1
(43) Pub. Date: Jun. 14, 2007

(54) Operator's crane

(76) Inventor: Anatoly Kokush, Kiev (UA)

Correspondence Address: Ilya Zborovsky, 6 Schoolhouse way, Dix Hills, NY, 11746, US

(21) Appl. No.: 10/405,270

(22) Filed: Apr. 2, 2003

(30) Foreign Application Priority Data
Apr. 4, 2002 (UA) 2002042685

(51) Int. Cl. G03B 17/00

(52) U.S. Cl. 396/428

(57) ABSTRACT

An operator's crane has a boom formed as a parallelogram mechanism which is located in a vertical plane and has longitudinal and transverse links, a support which supports a central part of the boom and placed on a base with a possibility of turning of the boom in vertical and horizontal planes, a camera and a counterweight located in a front and rear parts of the boom correspondingly, at least one further link extending parallel to the longitudinal links of the parallelogram mechanism and having a same length so as to form a second parallelogram mechanism which is located in a plane perpendicular to a plane of the first mentioned parallelogram mechanism.

### BACKGROUND OF THE INVENTION

The present invention relates to cranes, and in particular to operator's cranes which are used from displacement and turning of a camera during movie and TV shooting.

An operator's crane is known (U.S.A. magazine InSync, Publications, September 2001, the International Trade Magazine “for TV, video and motion picture equipment” page 38) for manual spacial displacement of a camera, which includes a boom formed as a parallelogram mechanism located in a vertical plane with longitudinal and transverse links with the rear transverse link of the boom is placed on a support located on a base with the possibility of turning of the boom in vertical and horizontal planes, a camera and a counterweight on a cantilever located in the front and rear parts of the boom, and also a seat for an operator located on the support (page 38 from the magazine with the picture of this crane).

Another operator's crane which is closer to the present invention is an operator's crane “Egripment” Company which includes a boom formed as a parallelogram mechanism located in a vertical plane with longitudinal and transverse links on a base of the boom, formed with the possibility of vertical and horizontal turns and located on a base which is formed as a carriage with a handle for convenience of displacement. A head with a camera is located on the front end of the boom on a transverse link. A counterweight is connected to another transverse link at the end of the boom (a leaflet with the picture of the operator's crane “Agripment” is enclosed.

The above mentioned operator's cranes has the following disadvantages:
narrow possibilities for panoraming of the camera within the limits of displacement of the crane boom, or in other words in vertical and horizontal planes, and also with the direct action by the operator on the crane head, which creates discomfort connected with lifting and lowering of the camera within physical possibilities of the operator and limitation of the angle of panoraming of the camera; also, smoothness of movement of the boom and panoraming of the camera is provided only by a liquid friction of the head, which is clearly insufficient for the use during shooting with long-focus optical systems.

### SUMMARY OF THE INVENTION

Accordingly, it is an object of the present invention to provide an operator's crane which is a further improvement of the existing operator's cranes.

The technical results which can be obtained during an operation of the proposed operator's crane include a significant broadening of a range of panoraming of the camera with simultaneous substantial smoothness of camera movement and comfort in controlling the crane by an operator during shooting.

In keeping with these objects and with others which will become apparent hereinafter, one feature of the present invention resides, briefly stated, in an operator's crane, comprising a boom formed as a parallelogram mechanism which is located in a vertical plane and has longitudinal and transverse links; a support which supports a central part of said boom and placed on a base with a possibility of turning of said boom in vertical and horizontal planes; a camera and a counterweight located in front and rear parts of said boom correspondingly; at least one further link extending parallel to said longitudinal links of said parallelogram mechanism and having a same length so as to form a second parallelogram mechanism which is located in a plane perpendicular to a plane of said first mentioned parallelogram mechanism.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an operator's crane in accordance with the present invention;

FIG. 2 is a front view of the operator's crane in accordance with the present invention in direction of arrow A;

FIG. 3 is a view showing a section of the operator's crane in its central part identified as III-III in FIG. 1;

FIG. 4 is a view of the central part on the operator's crane as seen in direction of the arrow IV in FIG. 1;

FIG. 5 is a plan view of the operator's crane in accordance with the present invention during panoraming with a camera in a horizontal plane;

FIG. 6 is a view of the inventive operator's crane from the side, during panoraming in a vertical plane.

### DESCRIPTION OF THE PREFERRED EMBODIMENTS

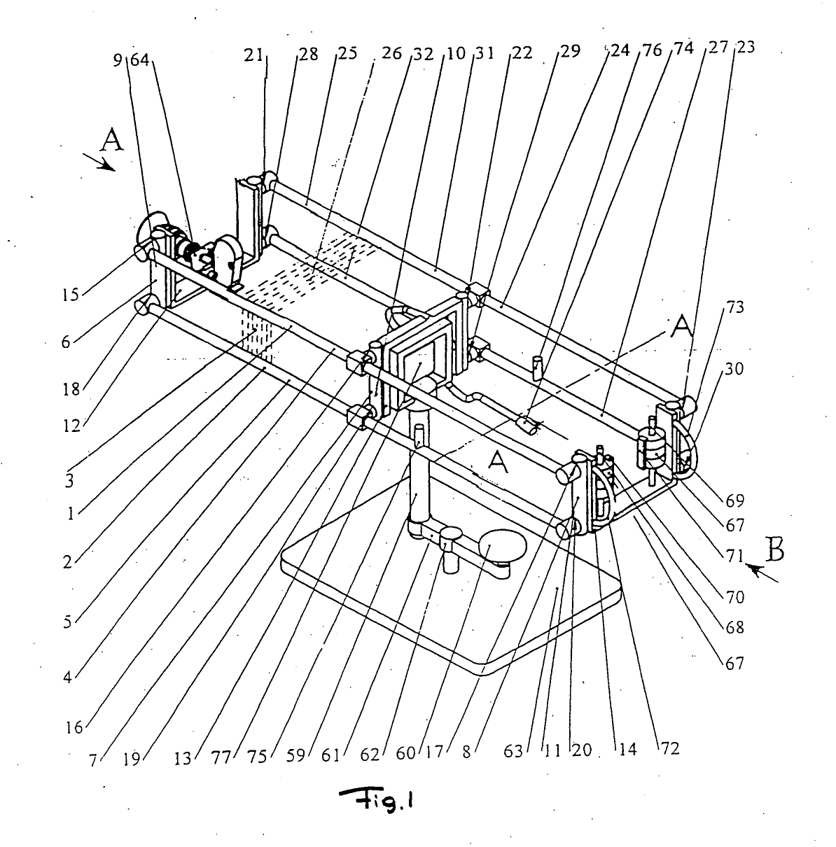

An operator's crane shown in FIG. 1 includes a boom 1 which is formed as a parallelogram mechanism 2 located in a vertical plane 3 and having longitudinal 4, 5, and transverse 6, 7, 8, links. At least one link 24 which is parallel to the longitudinal links 4, 5, of the parallelogram mechanism 2 is connected to a front 9, a central 10 and a rear 11 parts of the parallelogram mechanism 2 by a front 12, a center 13 and a rear cantilever by two-axes hinge connections 15, 16,1718, 19, 20, 21, 22, 23, so as to form a second parallelogram mechanism 25 which is located in a plane 26 perpendicular to the vertical plane 3 of the parallelogram mechanism 2.

A further longitudinal link 27 is connected by two-axes hinge connections 28,29,30 to form two more parallelogram mechanisms, namely a third parallelogram mechanism 31 which is located in a plane which is parallel to the vertical plane 3 of the parallelogram mechanism 2 and in the plane perpendicular to the plane 26 of the second parallelogram mechanism 25, and a fourth parallelogram mechanism 32 which is located in a plane perpendicular to the planes of the parallelogram mechanisms 2 and 3 and parallel to the plane 26 of the second parallelogram mechanism 25.

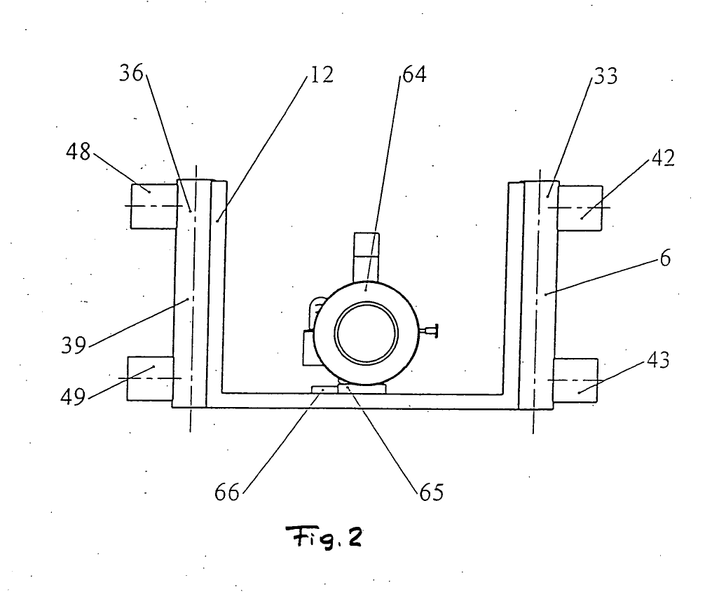

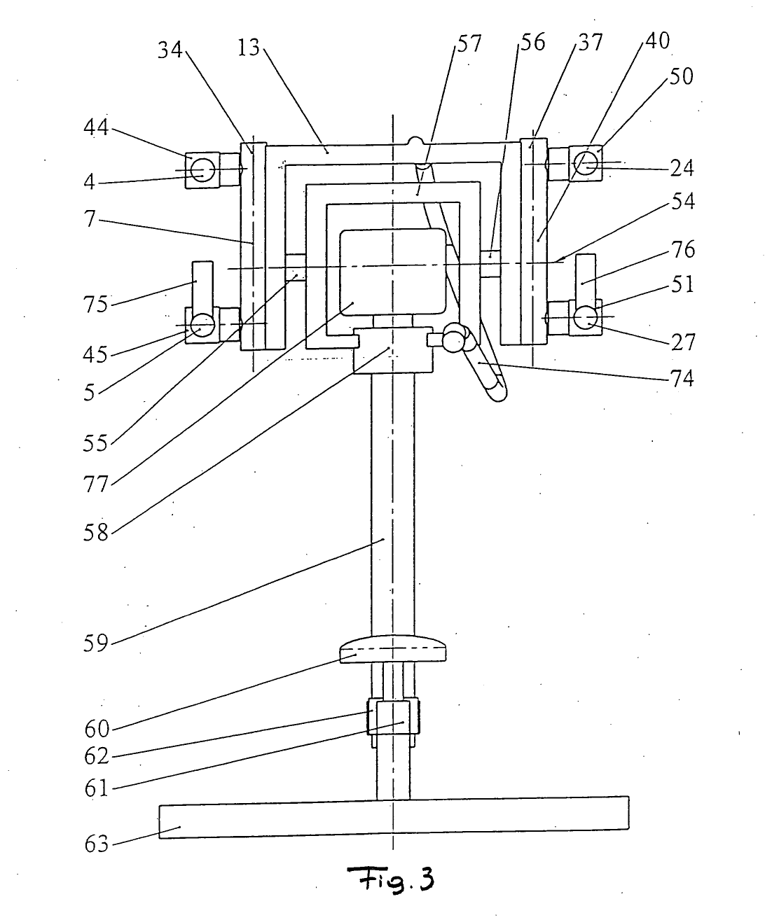

Every two-axes hinge connection 15, 16, 17, 18, 19, 20, 21, 22, 23, 28, 29, 30 which connects the parallelogram mechanism 2 with the cantilevers 12, 13, 14, and longitudinal links 24 and 27 can be formed as spherical hinges or pairs composed of a horizontal and a vertical hinge as shown in FIGS. 2, 3, 4. The vertical hinges 33, 34, 35, 36, 37, 38 are fixed on the transverse sides of the cantilevers 12, 13,14, and the vertical hinges 33, 34, 35, 36, 37, 38 simultaneously form transverse links 6, 7, 8, 39, 40, 41, of the parallelogram mechanisms 2 and 31. Horizontal hinges 42, 43, 44, 45, 46, 47, 48,49, 50, 51, 52, 53, are connected with the vertical hinges 33, 34, 35, 36, 37, 38 and with longitudinal links 4, 5, 24, 27 (shown in FIGS. 1 and 3) and provide displacement of the units of the boom 1 in a horizontal and in a vertical plane.

A horizontal axis 54 which extends through the center of mass of the boom 1 is an axis of two horizontal hinges 55, 56 connecting the cantilever 13 arranged on them and the frame 57 located in it and fixed on a unit of horizontal turning 58 located on a support 59 which, together with an operator's seat 60, is arranged at different ends of a coulisse 61 which is mounted by a mechanism of horizontal turning 62 in a base 63. The operator's seat 60 is located in a space between the transverse links 4 and 24 of the second parallelogram mechanism 25 above a base 63 and between the center 13 and the rear cantilevers.

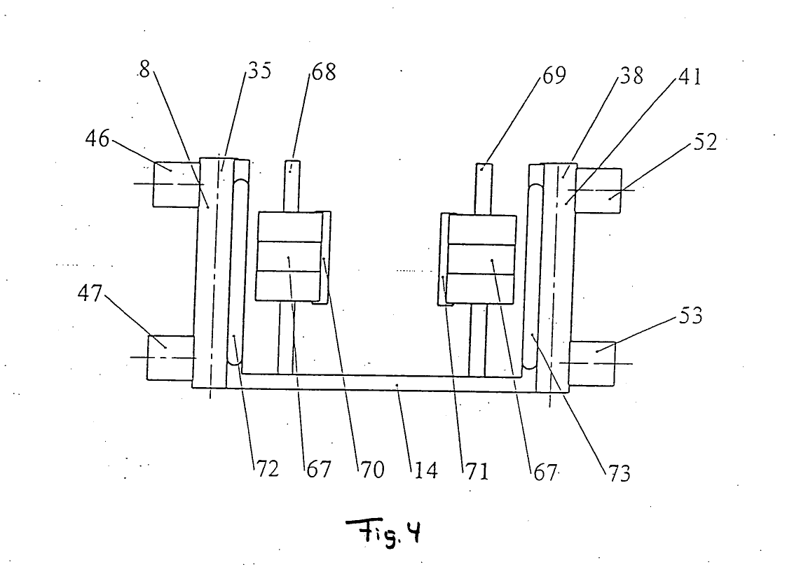

A camera 64 shown in FIGS. 1 and 2 is located on the front cantilever 12 so as it can move along a guide 65 with a clamp 66. A counterweight 67 shown in FIGS. 1 and 4 is located at a maximum distance from the center of mass of the boom 1 and is composed of two sets of weights located on guides 68 and 69 which are situated along left and right edges of the rear cantilever 14 and also two clamps 70, 71. Handles for controlling panoraming of the cameras 64 and inclination of the boom 72, 73 shown in FIGS. 1, 3, 4 are located on the rear cantilever 14. A handle 74 shown in FIGS. 1 and 3 is provided for panoraming with the camera 64 located on the central cantilever 13. Handles 75 and 76 for controlling the boom 1 are fixed on the longitudinal links 5 and 27. A video monitor 77 is located in the frame 57 of the central cantilever 17. The operator's crane can be also arranged on a carriage or a lifting device.

The crane in accordance with the present invention is prepared for operation as follows:

For starting of work, a balancing of the camera 61 shown in FIGS. 1 and 2 is carried out along the guide 65 until the front cantilever 12 assumes a vertical position, and the camera 64 is fixed by the clamp 66. Then a balancing of the boom 1 is carried out by the counterweight 67 and relative to the vertical axis of the support 59 shown in FIGS. 2, 3, until the boom assumes a horizontal position. A final balancing relative to the horizontal axis 54 of the horizontal hinges 55, 56 of the central cantilever 16 is performed by vertical movement of the weights of the counterweight 67 shown in FIGS. 1, 4 along the guides 68 and 69 until the central cantilever 13 assumes a vertical position. Then fixation of the counterweight 67 by the clamps 70 and 71 is performed.

Control of the panoraming of the camera and the boom can be performed from two positions of operator.

First position: The operator controls the boom 1 and the camera 64 while sitting on the seat 60 as shown in FIGS. 1, 3, and being located inside a space between the longitudinal links 4 and 24, and also between the central 13 and rear 14 cantilevers, by visually observing a panorama for shooting by the camera 64 on the video monitor 77 or by means of special video spectacles. He controls with his one hand the panoraming of the camera 64 by acting on the handle 74 in horizontal and vertical directions as shown in FIGS. 1, 5, 6. With the second hand he controls an inclination of the boom by acting on one of the handles 75, 76. Therefore, with a change of an angle of inclination of the cantilever 13 in horizontal and vertical planes by means of the handle 74 the operator inclines and turns the front cantilever 12 so as to move closer to or farther from one another the longitudinal links 4, 5, 24, 27 of the boom 1 in vertical and horizontal planes. The cantilever 12 with the camera 64 completely copies the hand movements of the operator, and he can control the image on the video monitor 77 or by means of the video spectacles. When it is necessary to turn the boom 1, the operator by means of his legs turns the coulisse 61 together with the support 59 and the boom 1 installed on it.

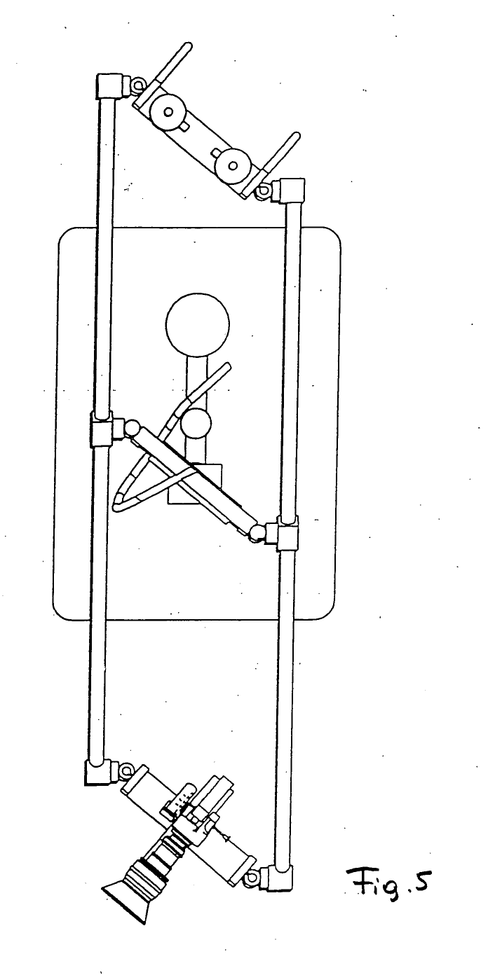

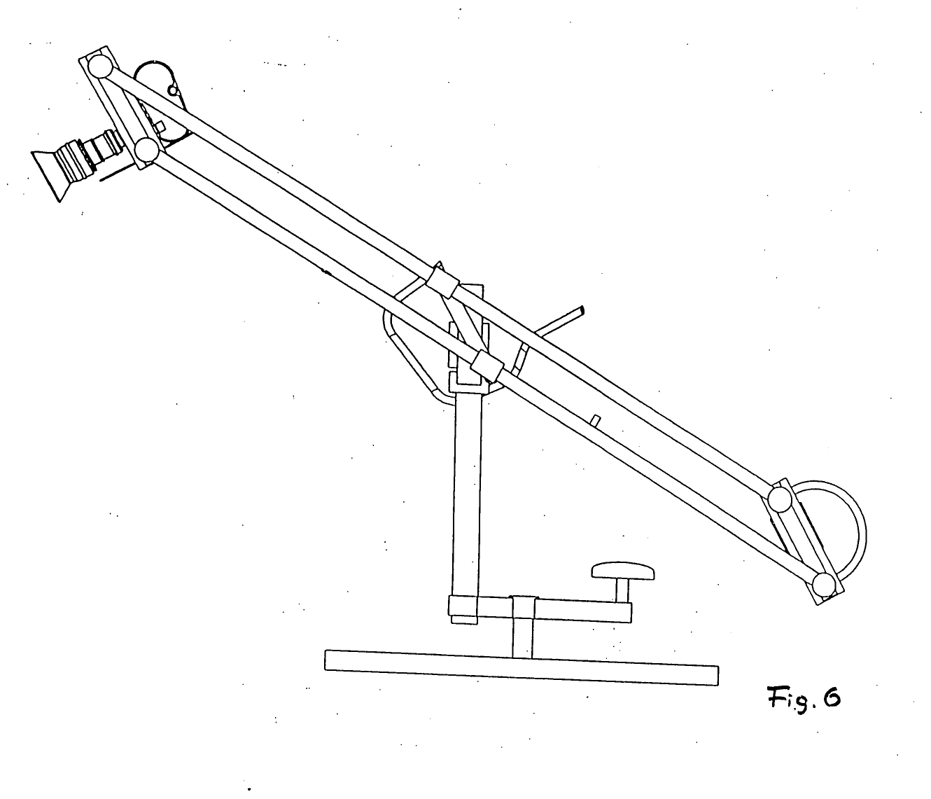

Second position. The operator controls the boom 1 and the camera 64 when he stands near a rear part 11 of the boom 1 of the crane as shown in FIGS. 1, 5, and applies a moment to various parts of the handles 72, 73. He holds his left hand in the upper part of the handle 72, and his right hand in the lower part of the handle 73 or vice versa, and folds together the longitudinal links 4, 5, 24, 27 in a vertical plane as shown in FIGS. 5, 6. Therefore, a panoraming by the camera 64 is performed along a vertical plane. At the same time, by applying various forces to the left and right handles, folding the longitudinal links 4, 27, and 5, 24 in the planes of the second 25 and fourth 32 parallelogram mechanisms shown in FIG. 5 he performs panoraming with the camera 64 in a horizontal plane. A lifting and turning of the boom 1 of the crane is performed in a conventional manner, while an observation is performed as in the first case on the screen of the video monitor 77 or by means of video spectacles.

It will be understood that each of the elements described above, or two or more together, may also find a useful application in other types of constructions differing from the types described above.

While the invention has been illustrated and described as embodied in operator's crane, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An operator's crane, comprising a boom formed as a parallelogram mechanism which is located in a vertical plane and has longitudinal and transverse links; a support which supports a central part of said boom and placed on a base with a possibility of turning of said boom in vertical and horizontal planes; a camera and a counterweight located in a front and rear parts of said boom correspondingly; at least one further link extending parallel to said longitudinal links of said parallelogram mechanism and having a same length so as to form a second parallelogram mechanism which is located in a plane perpendicular to a plane of said first mentioned parallelogram mechanism.

2. An operator's crane as defined in claim 1; and further comprising front, central and rear cantilevers which are connected by two-axes hinge connections to front, central and rear parts of said first mentioned parallelogram mechanism.

3. An operator's crane as defined in claim 2, wherein said central cantilever is located on a support and is turnable around a horizontal axis extending through a center of mass of said boom.

4. An operator's crane as defined in claim 2, wherein a horizontal axis which extends through said center of mass of a boom is an axis of two horizontal hinges which connect said central cantilever and a frame located inside said central cantilever and fixed on a unit for a horizontal turning located on said support.

5. An operator's crane as defined in claim 2; and further comprising an operator's seat located between longitudinal links of said second parallelogram mechanism above said base and between said central and rear cantilevers.

6. An operator's crane as defined in claim 2, wherein said counterweight is composed of two sets of weights located on a guide which extend along left and right edges of said rear cantilever.

7. An operator's crane as defined in claim 2, wherein each two-axes hinge connection which connects said first mentioned parallelogram mechanism with cantilevers and a longitudinal link is formed as a pair of horizontal and vertical hinges.

8. An operator's crane as defined in claim 7, wherein said vertical hinges are mounted on transverse sides of said cantilevers and form said transverse links of said first mentioned parallelogram mechanism.

9. An operator's crane as defined in claim 2, wherein each two-axes hinge connection which connects said first mentioned parallelogram mechanism with said cantilevers and one of said longitudinal links is formed as a spherical hinge.

10. An operator's crane as defined in claim 2, wherein said central and rear cantilevers are provided with handles for controlling said beam and panoraming said camera.

11. An operator's crane as defined in claim 2; and further comprising a video monitor located in a frame on said central cantilever.
